(19) United States
(12) Patent Application Publication
(10) Pub. No.: US 2026/0258634 A1
(43) Pub. Date: Sep. 3, 2026

(54) REMOTE OPERATION SYSTEM FOR WORK MACHINE AND REMOTE OPERATION METHOD FOR WORK MACHINE

(71) Applicant: KOMATSU LTD., Tokyo (JP)

(72) Inventor: Masanori AIZAWA, Minato-ku, Tokyo (JP)

(73) Assignee: KOMATSU LTD., Tokyo (JP)

(21) Appl. No.: 19/163,396

(22) PCT Filed: Feb. 21, 2024
(86) PCT No.: PCT/JP2024/006245

§ 371 Date: Sep. 9, 2025

(30) Foreign Application Priority Data
Mar. 31, 2023 (JP) 2023-058266

(51) Int. Cl. E02F 9/20; G08C 17/02; H04N 7/18

(52) U.S. Cl. CPC E02F 9/205; G08C 17/02; H04N 7/185; G08C 2201/42

(57) ABSTRACT

A remote operation system for a work machine includes: a remote controller associated with a remote operation device and configured to transmit, based on an operation signal from the remote operation device, an operation command; a relay controller associated with a work machine and configured to receive the operation command; an operation command transmitter configured to transmit the operation command relayed by the relay controller to the work machine; and a management controller configured to connect communication between the remote controller that is specific and the relay controller that is specific.

### TECHNICAL FIELD

The present disclosure relates to a remote operation system for a work machine and a remote operation method for a work machine.

### BACKGROUND ART

In the technical field related to a remote operation system for a work machine, a work support system as disclosed in Patent Document 1 is known.

### CITATION LIST

### Patent Literature

Patent Document 1: JP 2022-154873 A

### SUMMARY OF INVENTION

### Technical Problem

In a remote operation system, a remote operation device and a work machine communicate with each other via a communication system. When there are a plurality of remote operation devices or when there are a plurality of work machines, it is necessary to determine a combination of a remote operation device and a work machine to be remotely operated.

An object of the present disclosure is to determine a combination of a remote operation device and a work machine to be remotely operated.

### Solution to Problem

The present disclosure provides a remote operation system for a work machine including: a remote controller associated with a remote operation device and configured to transmit, based on an operation signal from the remote operation device, an operation command; a relay controller associated with a work machine and configured to receive the operation command; an operation command transmitter configured to transmit the operation command relayed by the relay controller to the work machine; and a management controller configured to connect communication between the remote controller that is specific and the relay controller that is specific.

### Advantageous Effects of Invention

The present disclosure can determine a combination of a remote operation device and a work machine to be remotely operated.

### BRIEF DESCRIPTION OF DRAWINGS

FIG. 1 is a diagram schematically illustrating a remote operation system of work machines according to a first embodiment.

FIG. 2 is a diagram schematically illustrating the work machine according to the first embodiment.

FIG. 3 is a block diagram illustrating the remote operation system according to the first embodiment.

FIG. 4 is a diagram illustrating a display example of a display device according to the first embodiment.

FIG. 5 is a flow chart depicting a remote operation method according to the first embodiment.

FIG. 6 is a diagram schematically illustrating a remote operation system of work machines according to a second embodiment.

FIG. 7 is a diagram schematically illustrating the work machines and dump trucks according to the second embodiment.

FIG. 8 is a flow chart depicting a remote operation method according to the second embodiment.

FIG. 9 is a block diagram illustrating a computer system according to an embodiment.

### DESCRIPTION OF EMBODIMENTS

Hereinafter, embodiments according to the present disclosure will be described with reference to the drawings, but the present disclosure is not limited to the embodiments. Components of the embodiments described below can be combined as appropriate. Some components are not used in some cases.

### First Embodiment

A first embodiment will be described.

### Overview of Remote Operation System

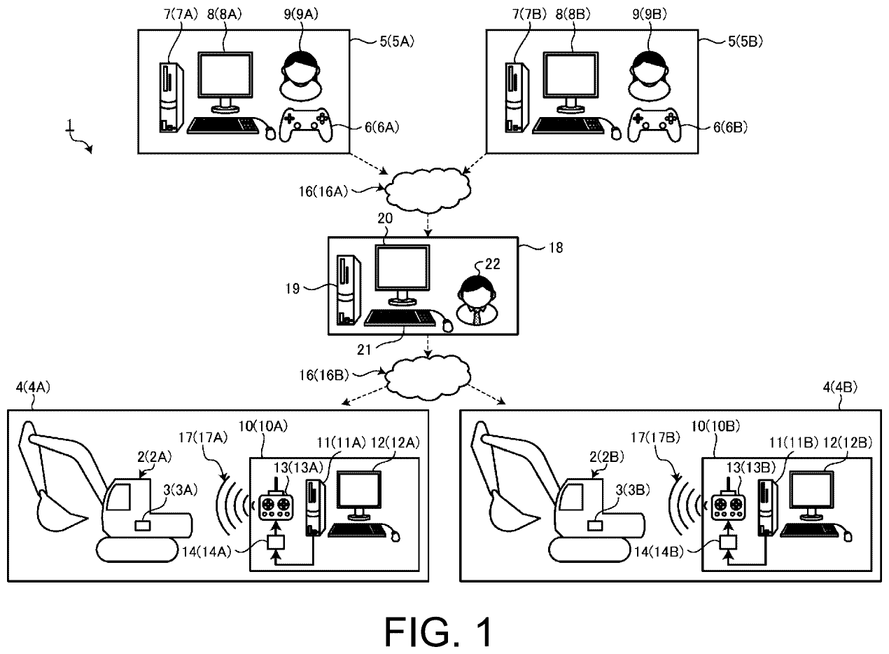

FIG. 1 is a diagram schematically illustrating a remote operation system 1 of work machines 2 according to the present embodiment. The remote operation system 1 remotely operates the work machine 2 that operates at a work site 4. In the present embodiment, the work machine 2 is a hydraulic excavator.

The remote operation system 1 includes an in-vehicle controller 3, a remote operation device 6, a remote controller 7, a display device 8, a management controller 19, a display device 20, an input device 21, a relay controller 11, a display device 12, a conversion device 14, and an operation command transmitter 13.

There are a plurality of the work machines 2. There are a plurality of the work sites 4. In the present embodiment, the work machines 2 include a work machine 2A and a work machine 2B. The work sites 4 include a work site 4A where the work machine 2A operates and a work site 4B where the work machine 2B operates. For example, a plurality of the work machines 2 may be at one work site 4.

The in-vehicle controller 3 includes a computer system disposed in the work machine 2. The in-vehicle controllers 3 include an in-vehicle controller 3A disposed in the work machine 2A and an in-vehicle controller 3B disposed in the work machine 2B.

Each of the remote operation device 6, the remote controller 7, and the display device 8 is disposed outside the work machine 2. Each of the remote operation device 6, the remote controller 7, and the display device 8 is disposed at a remote location of the work site 4. A remote operation room 5 is installed at the remote location of the work site 4. Each of the remote operation device 6, the remote controller 7, and the display device 8 is disposed in the remote operation room 5.

There are a plurality of the remote operation devices 6. There are a plurality of the remote controllers 7. There are a plurality of the display devices 8. There are a plurality of the remote operation rooms 5. In the present embodiment, the remote operation devices 6 include a remote operation device 6A and a remote operation device 6B. The remote controllers 7 include a remote controller 7A and a remote controller 7B. The display devices 8 include a display device 8A and a display device 8B. The remote operation rooms 5 include a remote operation room 5A where the remote operation device 6A, the remote controller 7A, and the display device 8A are disposed, and a remote operation room 5B where the remote operation device 6B, the remote controller 7B, and the display device 8B are disposed.

The remote controller 7 is associated with the remote operation device 6 on a one-to-one basis. The remote controller 7A is associated with the remote operation device 6A. The remote controller 7B is associated with the remote operation device 6B. Specifying the remote controller 7A means specifying the remote operation device 6A. Specifying the remote controller 7B means specifying the remote operation device 6B. Further, the display device 8A is associated with the remote controller 7A. The display device 8B is associated with the remote controller 7B.

Each of the relay controller 11, the display device 12, the conversion device 14, and the operation command transmitter 13 is disposed outside the work machine 2. Each of the relay controller 11, the display device 12, the conversion device 14, and the operation command transmitter 13 is disposed at the work site 4 where the work machine 2 operates. A relay room 10 is installed at the work site 4. Each of the relay controller 11, the display device 12, the conversion device 14, and the operation command transmitter 13 is disposed in the relay room 10.

There are a plurality of the relay controllers 11. There are a plurality of the display devices 12. There are a plurality of the conversion devices 14. There are a plurality of the operation command transmitters 13. There are a plurality of the relay rooms 10. In the present embodiment, the relay controllers 11 include a relay controller 11A and a relay controller 11B. The display devices 12 include a display device 12A and a display device 12B. The conversion devices 14 include a conversion device 14A and a conversion device 14B. The operation command transmitters 13 include an operation command transmitter 13A and an operation command transmitter 13B. The relay rooms 10 include a relay room 10A where the relay controller 11A, the display device 12A, the conversion device 14A, and the operation command transmitter 13A are disposed, and a relay room 10B where the relay controller 11B, the display device 12B, the conversion device 14B, and the operation command transmitter 13B are disposed. The relay room 10A is disposed at the work site 4A. The relay room 10B is disposed at the work site 4B.

The relay controller 11 is associated with the work machine 2 on a one-to-one basis. The relay controller 11A is associated with the work machine 2A. The relay controller 11B is associated with the work machine 2B. Specifying the relay controller 11A means specifying the work machine 2A. Specifying the relay controller 11B means specifying the relay controller 11B. Further, the display device 12A is associated with the relay controller 11A. The display device 12B is associated with the relay controller 11B. The conversion device 14A is associated with the relay controller 11A. The conversion device 14B is associated with the relay controller 11B. The operation command transmitter 13A is associated with the relay controller 11A. The operation command transmitter 13B is associated with the relay controller 11B.

The remote controller 7 includes a computer system disposed in the remote operation room 5. The display device 8 includes a flat panel display such as a liquid crystal display or an organic EL display. An operator 9 is in the remote operation room 5. The operator 9 operates the remote operation device 6. A game pad is exemplified as the remote operation device 6. The remote operation device 6 is operated by the operator 9 at the remote operation room 5. Remote operations include, for example, an operation performed from a position where the operator 9 cannot visually observe the work machine 2. The operator 9 can observe the display device 8.

There are a plurality of the operators 9. In the present embodiment, the operators 9 include an operator 9A who operates the remote operation device 6A at the remote operation room 5A and an operator 9B who operates the remote operation device 6B at the remote operation room 5B. The operator 9A can observe the display device 8A. The operator 9B can observe the display device 8B.

Each of the management controller 19, the display device 20, and the input device 21 is disposed outside the work machine 2. Each of the management controller 19, the display device 20, and the input device 21 is disposed at a remote location of the work site 4. A server room 18 is installed at the remote location of the work site 4. Each of the management controller 19, the display device 20, and the input device 21 is disposed in the server room 18.

The management controller 19 includes a computer system disposed in the server room 18. The display device 20 includes a flat panel display such as a liquid crystal display or an organic EL display. The input device 21 includes, for example, a touch panel, a computer keyboard, or a mouse. A manager 22 is in the server room 18. The manager 22 operates the input device 21. The input device 21 is operated by the manager 22 at the server room 18. The manager 22 can observe the display device 20. For example, the manager 22 does not need to be in the server room 18.

The remote operation device 6 generates an operation signal for remotely operating the work machine 2. The operation signal generated at the remote operation device 6 is output to the remote controller 7. The remote controller 7 generates a first operation command on the basis of the operation signal from the remote operation device 6. As described above, the remote operation device 6 and the remote controller 7 are associated with each other on a one-to-one basis. An operation signal generated at the remote operation device 6A is output to the remote controller 7A. The remote controller 7A generates a first operation command on the basis of the operation signal from the remote operation device 6A. An operation signal generated at the remote operation device 6B is output to the remote controller 7B. The remote controller 7B generates a first operation command on the basis of the operation signal from the remote operation device 6B.

The remote controller 7 transmits the first operation command to the relay controller 11 via a first communication system 16 and the management controller 19. The first operation command is an operation command for operating the operation command transmitter 13.

In the present embodiment, the first communication system 16 includes a first communication system 16A in which the remote controller 7 communicates with the management controller 19 and a first communication system 16B in which the management controller 19 communicates with the relay controller 11. The remote controller 7A transmits a first operation command to the management controller 19 via the first communication system 16A. The remote controller 7B transmits a first operation command to the management controller 19 via the first communication system 16A.

The first communication system 16 transmits a first operation command with a first communication method (first communication protocol). The first communication system 16 transmits a first operation command via, for example, a telecommunication line. The first communication system 16 may include a public communication line or may include a dedicated communication line. As the first communication system 16, the Internet is exemplified. The first communication system 16 may include a local area network, a cellular phone communication network, or a satellite communication network. In the present embodiment, the first communication method is the Internet method.

When receiving a first operation command from the remote controller 7A, the management controller 19 can transmit the first operation command to one of the relay controller 11A and the relay controller 11B via the first communication system 16B. When receiving a first operation command from the remote controller 7B, the management controller 19 can transmit the first operation command to one of the relay controller 11A and the relay controller 11B via the first communication system 16B.

The relay controller 11 includes a computer system disposed in the relay room 10. The display device 12 includes a flat panel display such as a liquid crystal display or an organic EL display.

The conversion device 14 converts a first operation command of the first communication method transmitted from the remote controller 7 via the management controller 19 into a second operation command of a second communication method. The first operation command transmitted from the remote controller 7 with the first communication method is transmitted to the conversion device 14 via the relay controller 11. The conversion device 14 converts the first operation command of the first communication method into a second operation command of the second communication method. The conversion device 14 includes, for example, a microcomputer and a low-pass filter circuit. The second operation command converted from the command for the first communication method to the command for the second communication method by the conversion device 14 is transmitted to the operation command transmitter 13.

The operation command transmitter 13 transmits the second operation command of the second communication method on the basis of the first operation command from the remote operation device 6. The operation command transmitter 13 transmits the second operation command to the in-vehicle controller 3 of the work machine 2 via a second communication system 17. The second operation command is an operation command for operating the work machine 2. The work machine 2 operates on the basis of the second operation command from the operation command transmitter 13.

In the present embodiment, the second communication system 17 includes a second communication system 17A in which the operation command transmitter 13A communicates with the in-vehicle controller 3A, and a second communication system 17B in which the operation command transmitter 13B communicates with the in-vehicle controller 3B. The operation command transmitter 13A transmits a second operation command to the in-vehicle controller 3A via the second communication system 17A. The operation command transmitter 13B transmits a second operation command to the in-vehicle controller 3B via the second communication system 17B. The work machine 2 operates on the basis of the second operation command from the operation command transmitter 13. The work machine 2A operates on the basis of the second operation command from the operation command transmitter 13A. The work machine 2B operates on the basis of the second operation command from the operation command transmitter 13B.

The second communication system 17 transmits a second operation command to the work machine 2 with the second communication method (second communication protocol) different from the first communication method. The operation command transmitter 13 transmits a second operation command to the work machine 2 with the second communication method. The operation command transmitter 13 wirelessly transmits the second operation command to the work machine 2. The second communication system 17 transmits a second operation command by, for example, radio waves. In the present embodiment, the second communication method is a radio control method. The operation command transmitter 13 is a radio control transmitter. The work machine 2 is operated by radio control by the operation command transmitter 13. In the present embodiment, radio control operations include, for example, an operation performed from a position where a supervisor of the work site 4 can visually observe the work machine 2. The operation command transmitter 13 is disposed at a position where the supervisor can visually observe the work machine 2.

A radio station established for the second communication system 17 is, for example, a radio station that does not require a license and registration. When the second communication system 17 is used, no wireless worker qualification is required. The radio station established for the second communication system 17 may be a weak radio station for radio control whose frequency band of radio waves is a 73 MHz band or the like, a specified low power radio station for a 920 MHz band telemeter and telecontrol whose frequency band of radio waves is a 920 MHz band, or a 2.4 GHz band low power data communication system whose frequency band of radio waves is a 2.4 GHz band.

### Work Machine

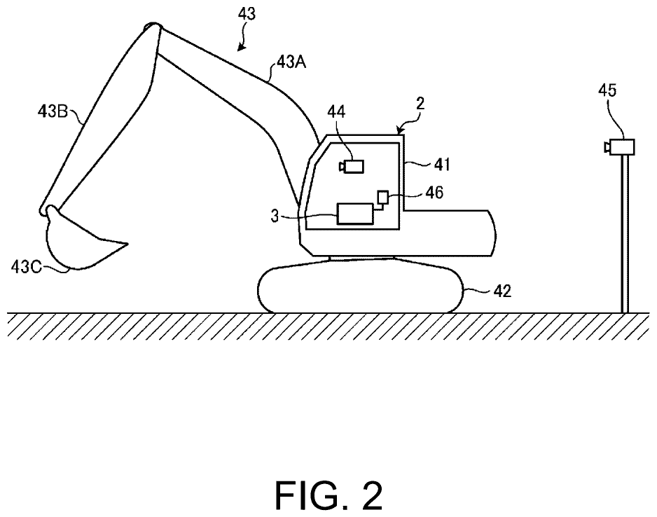

FIG. 2 is a diagram schematically illustrating the work machine 2 according to the present embodiment. The work machine 2 includes a revolving body 41, a traveling body 42, a work implement 43, a peripheral camera 44, an operation command receiver 46, and the in-vehicle controller 3.

The revolving body 41 revolves while being supported by the traveling body 42. The revolving body 41 revolves about a revolving axis. The traveling body 42 includes a left crawler belt and a right crawler belt.

The work implement 43 is supported by the revolving body 41. The work implement 43 includes a boom 43A, an arm 43B, and a bucket 43C. Each of the boom 43A, the arm 43B, and the bucket 43C operates about a rotating axis.

In the present embodiment, an up-down direction of the work machine 2 refers to a direction in which the revolving axis of the revolving body 41 extends. A left-right direction of the work machine 2 refers to a direction in which the rotating axis of the work implement 43 extends. A front-rear direction of the work machine 2 refers to a direction orthogonal to each of the up-down direction and the left-right direction. The revolving axis extends in the up-down direction of the revolving body 41. The rotating axis of work implement 43 extends in a left-right direction of revolving body 41.

The peripheral camera 44 is mounted at the work machine 2. The peripheral camera 44 is disposed in, for example, a cab provided at the revolving body 41. The peripheral camera 44 captures an image of a periphery of the revolving body 41. The peripheral camera 44 captures an image in front of the revolving body 41, for example. The periphery of the revolving body 41 includes the work site 4. The peripheral camera 44 captures an image of the work site 4.

The operation command receiver 46 receives a second operation command from the operation command transmitter 13. The operation command receiver 46 is a radio control receiver.

A site camera 45 is disposed in the work site 4. The site camera 45 is disposed outside the work machine 2. The site camera 45 captures an image of the work site 4 including a periphery of the work machine 2. The image captured by the site camera 45 is transmitted to the in-vehicle controller 3.

The in-vehicle controller 3 includes a computer system. The in-vehicle controller 3 controls operation of the work machine 2 on the basis of a second operation command. Further, the in-vehicle controller 3 transmits an image captured by the peripheral camera 44 and an image captured by the site camera 45 to the management controller 19. The in-vehicle controller 3 transmits an image of the work site 4 where the work machine 2 operates to the management controller 19 via the first communication system 16. In the present embodiment, the in-vehicle controller 3 transmits an image captured by the peripheral camera 44 and an image captured by the site camera 45 to the management controller 19 without passing through the second communication system 17.

Further, the in-vehicle controller 3 transmits an image captured by the peripheral camera 44 to the remote controller 7 via the first communication system 16. The in-vehicle controller 3 transmits an image captured by the peripheral camera 44 to the remote controller 7 without passing through the second communication system 17. The image captured by the peripheral camera 44 is displayed on the display device 8. The operator 9 of the remote operation room 5 operates the remote operation device 6 while observing the image of the work site 4 displayed on the display device 8.

### Remote Operation System

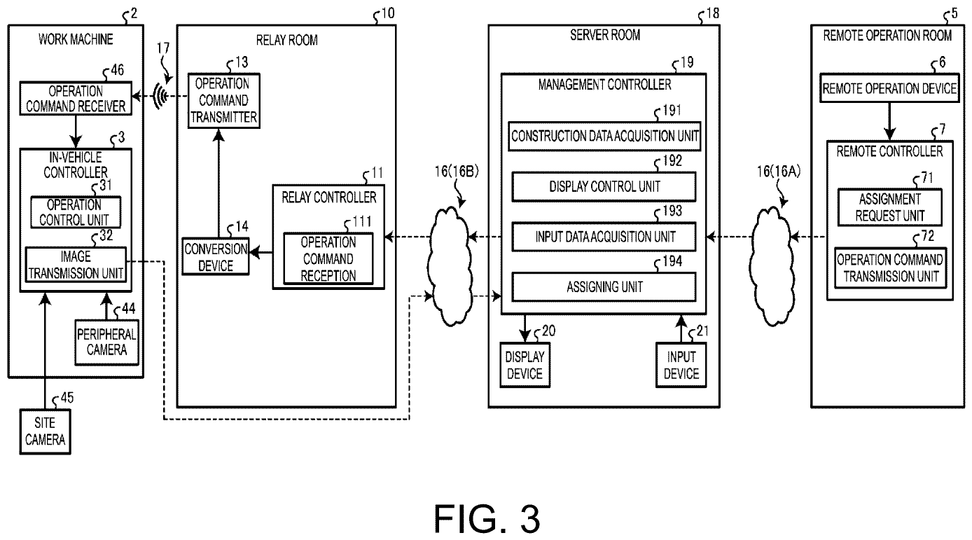

FIG. 3 is a block diagram illustrating the remote operation system 1 according to the present embodiment. The remote operation device 6 and the remote controller 7 are disposed in the remote operation room 5. The remote operation device 6 is operated by the operator 9, thereby generating an operation signal. The remote controller 7 is connected to the remote operation device 6.

The remote controller 7 includes an assignment request unit 71 and an operation command transmission unit 72.

The assignment request unit 71 transmits an assignment request for requesting performance of a remote operation of the work machine 2. In order to transmit an assignment request to the remote operation device 6, for example, an assignment request button is provided. When the operator 9 wants to perform a remote operation of the work machine 2, the operator 9 operates the assignment request button. When the assignment request button is operated, an assignment request is output from the remote operation device 6. The assignment request unit 71 transmits the assignment request to the management controller 19 via the first communication system 16A.

The operation command transmission unit 72 receives an operation signal for remotely operating the work machine 2 from the remote operation device 6. The operation command transmission unit 72 generates a first operation command on the basis of the operation signal from the remote operation device 6. The operation command transmission unit 72 transmits the first operation command to the management controller 19 via the first communication system 16A.

The management controller 19, the display device 20, and the input device 21 are disposed in the server room 18.

The management controller 19 includes a construction data acquisition unit 191, a display control unit 192, an input data acquisition unit 193, and an assigning unit 194.

The construction data acquisition unit 191 acquires construction data indicating a work situation of the work site 4 where the work machine 2 operates. In the present embodiment, the construction data includes an image of the work site 4 captured by at least one of the peripheral camera 44 and the site camera 45. An image transmission unit 32 of the in-vehicle controller 3 transmits the image of the work site 4 captured by at least one of the peripheral camera 44 and the site camera 45 to the management controller 19 via the first communication system 16B. The construction data acquisition unit 191 acquires, as the construction data, the image of the work site 4 captured by at least one of the peripheral camera 44 and the site camera 45.

The display control unit 192 causes the display device 20 to display the image of the work site 4 captured by at least one of the peripheral camera 44 and the site camera 45. The manager 22 can observe the image of the work site 4 displayed on the display device 20.

The input data acquisition unit 193 acquires input data from the input device 21. The input device 21 generates the input data by being operated by the manager 22. The input data generated in the input device 21 is transmitted to the management controller 19. The input data acquisition unit 193 acquires the input data transmitted from the input device 21.

The assigning unit 194 connects communication between a specific remote controller 7 and a specific relay controller 11. The assigning unit 194 connects, for example, communication between the remote controller 7 that has output an assignment request and a specific relay controller 11. The assigning unit 194 connects communication between the remote controller 7 and the relay controller 11 on the basis of, for example, construction data. For example, the communication between the remote controller 7 and the relay controller 11 may be connected by optional setting by the manager 22. The assigning unit 194 specifies, based on the construction data, from among the plurality of relay controllers 11 (11A and 11B), the relay controller 11 to which communication with the remote controller 7 that has output the assignment request is to be connected. For example, the relay controller 11 to which communication with the remote controller 7 that has output the assignment request is to be connected may be automatically specified, based on the construction data, from among the plurality of relay controllers 11 (11A and 11B).

In the present embodiment, the manager 22 observes the construction data indicating work situations of the plurality of work sites 4 (4A and 4B) displayed on the display device 20 and determines the work machine 2 to be remotely operated. The manager 22 operates the input device 21 in order to specify the work machine 2 to be remotely operated. The input data from the input device 21 is acquired by the input data acquisition unit 193. The assigning unit 194 connects communication between the remote controller 7 that has output the assignment request and the relay controller 11 associated with the work machine 2 specified by the input data on the basis of the input data from the input device 21 operated on the basis of the construction data displayed on the display device 20.

The relay controller 11, the conversion device 14, and the operation command transmitter 13 are disposed in the relay room 10.

The relay controller 11 includes an operation command reception unit 111.

The operation command reception unit 111 receives a first operation command transmitted from the remote controller 7 via the first communication system 16 and the management controller 19.

The conversion device 14 converts a first operation command transmitted from the remote controller 7 with the first communication method via the first communication system 16 and the management controller 19 into a second operation command of the second communication method.

The operation command transmitter 13 transmits a second operation command relayed by the relay controller 11 and generated by the conversion device 14 to the in-vehicle controller 3 of the work machine 2.

The operation command receiver 46, the in-vehicle controller 3, and the peripheral camera 44 are disposed in the work machine 2. In addition, the site camera 45 is disposed at the work site 4.

The in-vehicle controller 3 includes an operation control unit 31 and the image transmission unit 32.

The operation control unit 31 controls operation of the work machine 2 on the basis of a second operation command received by the operation command receiver 46. The work machine 2 operates on the basis of the second operation command. The operation of the work machine 2 includes revolving operation of the revolving body 41, traveling operation of the traveling body 42, and work operation of the work implement 43.

The image transmission unit 32 transmits an image of the work site 4 captured by the peripheral camera 44 and an image of the work site 4 captured by the site camera 45 to the management controller 19 and the remote controller 7 via the first communication system 16B. The image of the work site 4 captured by the peripheral camera 44 and the image of the work site 4 captured by the site camera 45 are transmitted to the server room 18 and the remote operation room 5 via the first communication system 16B without passing through the second communication system 17, and thus a decrease in work performance due to a video delay is suppressed.

### Display Device

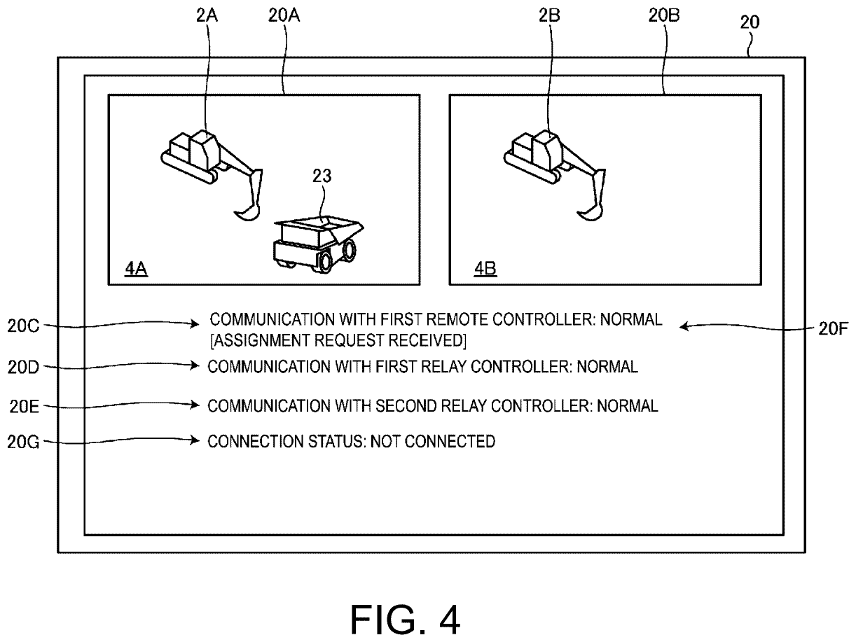

FIG. 4 is a diagram illustrating a display example of the display device 20 according to the present embodiment. As illustrated in FIG. 4, an image of the work site 4A is displayed in a first display area 20A of the display device 20 as construction data of the work site 4A, and an image of the work site 4B is displayed in a second display area 20B of the display device 20 as construction data of the work site 4B. In the example illustrated in FIG. 4, the work machine 2A and a dump truck 23 are at the work site 4A. At the work site 4A, the work machine 2A starts loading work for loading the dump truck 23 with a load. The work machine 2A is in an operating state. The work machine 2B is at the work site 4B, but the dump truck 23 is not. The work machine 2B is not performing loading work. The work machine 2B is in a resting state. That is, the resting state is a state in which radio control operations are enabled for the work machine 2B, is also a state in which remote operation is enabled, but is a state in which operation such as loading work is not performed.

Further, the display device 20 displays a message 20C indicating a communication status between the management controller 19 and the remote controller 7A (first remote controller), a message 20D indicating a communication status between the management controller 19 and the relay controller 11A (first relay controller), and a message 20E indicating a communication status between the management controller 19 and the relay controller 11B (second relay controller). In the example illustrated in FIG. 4, the communication status between the management controller 19 and the remote controller 7A is normal, and thus a message of “NORMAL” is displayed. Further, the communication status between the management controller 19 and the relay controller 11A is “NORMAL”, and the communication status between the management controller 19 and the relay controller 11B is “NORMAL”. When a communication status is abnormal, a message of “ABNORMAL” is displayed.

Further, a message 20G indicating a connection status of communication between the remote controller 7 and the relay controller 11 is displayed on the display device 20. In the example illustrated in FIG. 4, since communication between the remote controller 7A and the relay controller 11A and the relay controller 11B is not connected, a message of “NOT CONNECTED” is displayed. When communication between the remote controller 7A and the relay controller 11A or the relay controller 11B is connected, a message of “CONNECTED” is displayed.

Further, on the display device 20, “ASSIGNMENT REQUEST RECEIVED” is displayed as a message 20F indicating that an assignment request is output from the remote controller 7A. When no assignment request is output, the message 20F is not displayed.

The manager 22 observes the display device 20 and determines a combination of the remote controller 7 and the relay controller 11 to which communication is to be connected. In the example illustrated in FIG. 4, an assignment request is output from the remote controller 7A. Further, the work machine 2B at the work site 4B is in the resting state. Therefore, the manager 22 determines to connect communication between the remote controller 7A and the relay controller 11B associated with the work machine 2B. The manager 22 operates the input device 21 so that the communication between the remote controller 7A and the relay controller 11B is connected. The assigning unit 194 of the management controller 19 connects the communication between the remote controller 7A and the relay controller 11B on the basis of input data from the input device 21. Accordingly, the operator 9A can perform remote operation of the work machine 2B.

### Remote Operation Method

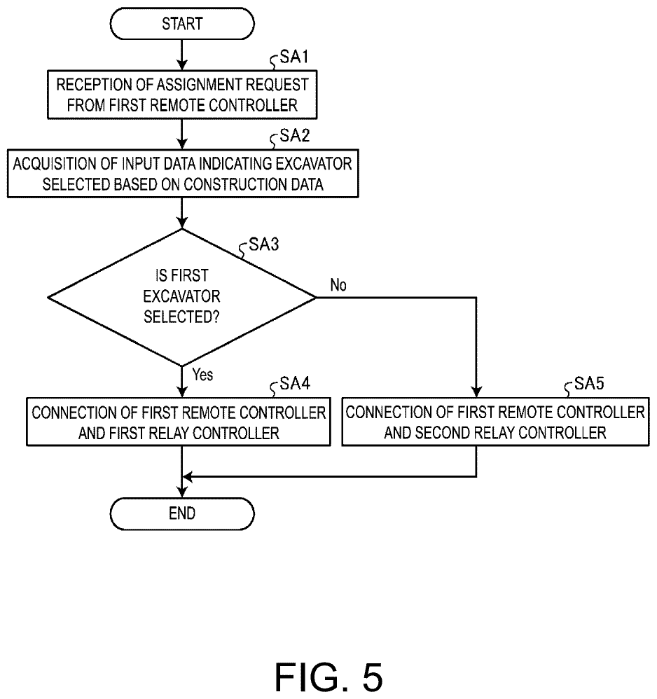

FIG. 5 is a flow chart depicting a remote operation method according to the present embodiment. The management controller 19 receives an assignment request from the remote controller 7A (step SA1).

The manager 22 observes work situations of the plurality of work sites 4 (4A and 4B) displayed on the display device 20, a communication status between the management controller 19 and the remote controller 7A, and communication statuses between the management controller 19 and the plurality of relay controllers 11 (11A and 11B). The manager 22 determines a combination of the remote controller 7 and the relay controller 11 to which communication is to be connected on the basis of the work situations of the plurality of work sites 4 (4A and 4B), the communication status between the management controller 19 and the remote controller 7A, the communication statuses between the management controller 19 and the plurality of relay controllers 11 (11A and 11B), and the assignment request.

When determining a combination of the remote controller 7 and the relay controller 11 to which communication is to be connected, the manager 22 operates the input device 21 so that communication between a specific remote controller 7 and a specific relay controller 11 is connected. The input data acquisition unit 193 of the management controller 19 acquires input data indicating the work machine 2 selected on the basis of construction data (step SA2).

The assigning unit 194 determines whether the work machine 2A (first excavator) has been selected on the basis of the input data (step SA3).

In step SA3, if it is determined that the work machine 2A (first excavator) is selected (step SA3: Yes), the assigning unit 194 connects communication between the remote controller 7A and the relay controller 11A associated with the work machine 2A (first excavator) (step SA4).

In step SA3, if it is determined that the work machine 2B (second excavator) is selected (step SA3: No), the assigning unit 194 connects communication between the remote controller 7A and the relay controller 11B associated with the work machine 2B (second excavator) (step SA5).

Effects As described above, the remote operation system 1 for the work machine 2 includes the remote controller 7 that is associated with the remote operation device 6 and transmits an operation command on the basis of an operation signal from the remote operation device 6, the relay controller 11 that is associated with the work machine 2 and receives the operation command, the operation command transmitter 13 that transmits the operation command relayed by the relay controller 11 to the work machine 2, and the management controller 19 that connects communication between a specific remote controller 7 and a specific relay controller 11.

According to the present embodiment, it is possible to appropriately determine a combination of the remote operation device 6 and the work machine 2 to be remotely operated. It is difficult for the operator 9 to recognize a work situation of each of a plurality of the work sites 4. In addition, there is a possibility that a plurality of the operators 9 simultaneously request assignment for one work machine 2. According to the present embodiment, the management controller 19 determines a combination of the remote operation device 6 and the work machine 2 to be remotely operated. The management controller 19 can acquire construction data indicating a work situation of the work site 4. Further, the management controller 19 can acquire assignment requests from a plurality of the operators 9. Therefore, the management controller 19 can appropriately determine a combination of the remote operation device 6 and the work machine 2 to be remotely operated.

### Second Embodiment

A second embodiment will be described. In the following description, components that are the same as or equivalent to those of the above-described embodiment are denoted by the same reference numerals, and description thereof is simplified or omitted.

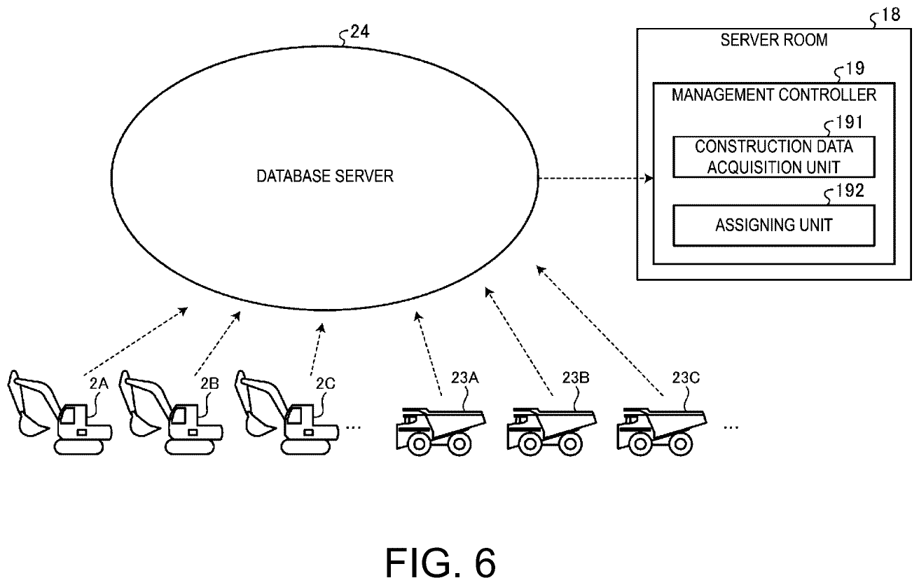

FIG. 6 is a diagram schematically illustrating the remote operation system 1 of the work machines 2 according to the present embodiment. In the present embodiment, the remote operation system 1 includes a database server 24 that collects construction data of each of a plurality of the work sites 4. In the present embodiment, the construction data includes operation data of each of a plurality of the work machines 2 (2A, 2B, 2C) and operation data of each of a plurality of the dump trucks 23 (23A, 23B, 23C). The operation data of the work machine 2 indicates that the work machine 2 is in an operating state or a resting state. The operation data of the work machine 2 includes a scheduled work start time of the work machine 2. The scheduled work start time of the work machine 2 includes a scheduled start time of loading work. The operation data of the dump truck 23 includes a position of the dump truck 23 and a scheduled arrival time at the work site 4.

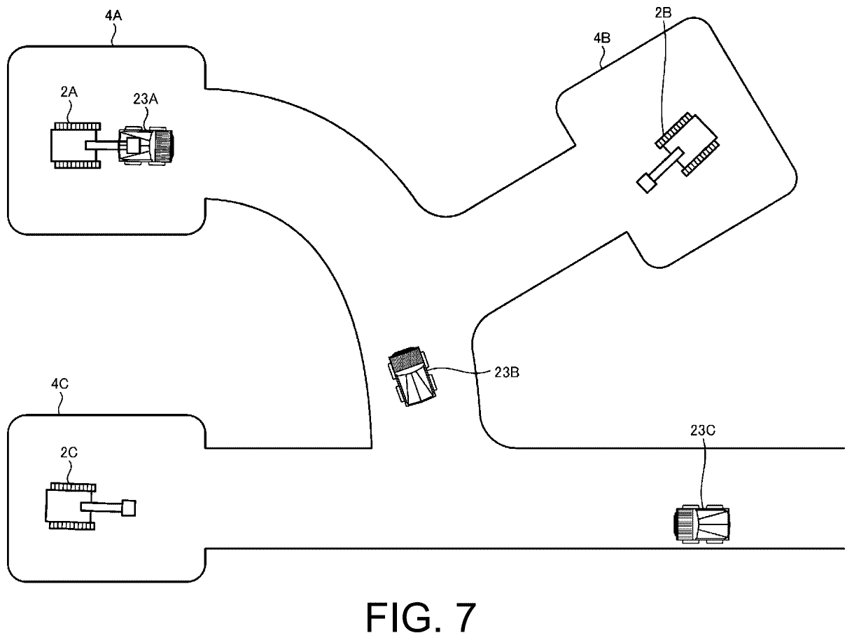

FIG. 7 is a diagram schematically illustrating the work machines 2 and the dump trucks 23 according to the present embodiment. The work machine 2A can perform loading work at the work site 4A. The work machine 2B can perform loading work at the work site 4B. The work machine 2C can perform loading work at the work site 4C. At the work site 4A, the work machine 2A performs loading work on the dump truck 23A. The work machine 2A is in an operating state. No dump trucks 23 are at the work site 4B and the work site 4C. The work machine 2B and the work machine 2C are in a resting state. The dump truck 23B and the dump truck 23C are not at the work sites 4 (4A, 4B, 4C) and are traveling on a road.

The dump truck 23B is traveling toward the work site 4B. The database server 24 can calculate a scheduled arrival time at which the dump truck 23B arrives at the work site 4B on the basis of a current position of the dump truck 23B and a traveling speed of the dump truck 23B. At the dump truck 23B, a position sensor such as a GNSS receiver that detects the current position of the dump truck 23B is mounted and a speed sensor that detects the traveling speed of the dump truck 23B is mounted. The database server 24 can calculate the scheduled arrival time at which the dump truck 23B arrives at the work site 4B on the basis of detection data of the position sensor and detection data of the speed sensor.

The dump truck 23C is traveling toward the work site 4C. The database server 24 can calculate a scheduled arrival time at which the dump truck 23C arrives at the work site 4C on the basis of a current position of the dump truck 23C and a traveling speed of the dump truck 23C.

The work machine 2B starts loading work when the dump truck 23B arrives at the work site 4B. The scheduled arrival time at which the dump truck 23B arrives at the work site 4B can be regarded as a scheduled work start time at which the work machine 2B starts loading work. Similarly, the scheduled arrival time at which the dump truck 23C arrives at the work site 4C can be regarded as a scheduled work start time at which the work machine 2C starts loading work.

The construction data acquisition unit 191 of the management controller 19 acquires, from the database server 24, the scheduled work start time of each of the work machine 2B and the work machine 2C as the construction data. The assigning unit 194 connects communication between a specific remote controller 7 and a specific relay controller 11 on the basis of the scheduled work start time of each of the work machine 2B and the work machine 2C.

For example, when the scheduled work start time of the work machine 2B is earlier than the scheduled work start time of the work machine 2C, the assigning unit 194 preferentially connects communication between the remote controller 7 that has output an assignment request and the relay controller 11B associated with the work machine 2B.

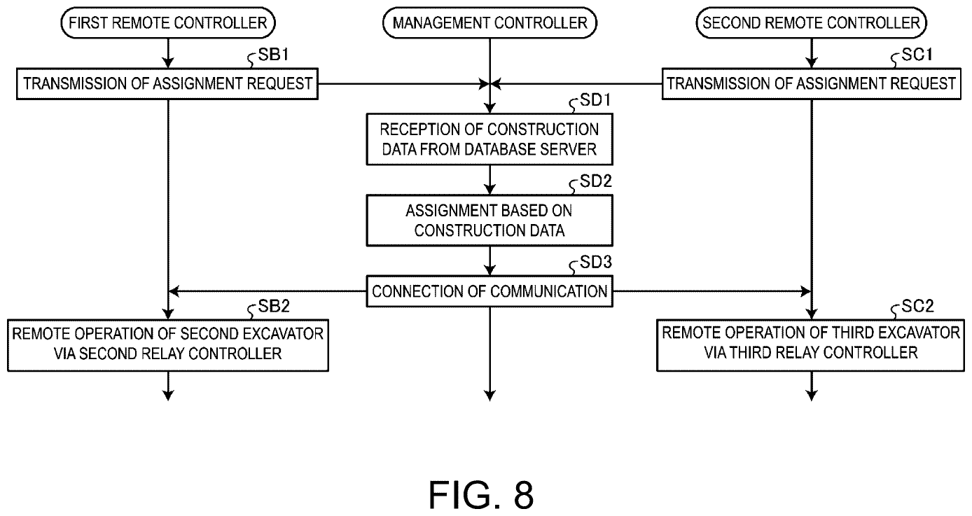

FIG. 8 is a flow chart depicting a remote operation method according to the present embodiment. The remote controller 7A transmits an assignment request to the management controller 19 (step SB1). The remote controller 7B transmits an assignment request to the management controller 19 (step SC1).

The management controller 19 receives the assignment request from the remote controller 7A and the assignment request from the remote controller 7B. The construction data acquisition unit 191 of the management controller 19 receives a scheduled work start time of each of a plurality of the work machines 2 from the database server 24 as construction data (step SD1).

The assigning unit 194 of the management controller 19 determines the relay controller 11 to be assigned to the remote controller 7A and the relay controller 11 to be assigned to the remote controller 7B on the basis of the scheduled work start time of each of the plurality of work machines 2 acquired from the database server 24 (step SD2).

For example, when the time at which the management controller 19 receives the assignment request from the remote controller 7A is earlier than the time at which the management controller 19 receives the assignment request from the remote controller 7B, and the scheduled work start time of the work machine 2B is earlier than the scheduled work start time of the work machine 2C, the assigning unit 194 assigns the relay controller 11B associated with the work machine 2B to the remote controller 7A and assigns the relay controller 11C associated with the work machine 2C to the remote controller 7B.

The assigning unit 194 connects communication between the remote controller 7A and the relay controller 11B and connects communication between the remote controller 7B and the relay controller 11C (step SD3).

Accordingly, the operator 9A can remotely operate the work machine 2B via the relay controller 11B associated with the work machine 2B (step SB2). The operator 9B can remotely operate the work machine 2C via the relay controller 11C associated with the work machine 2C (step SC2).

### Computer System

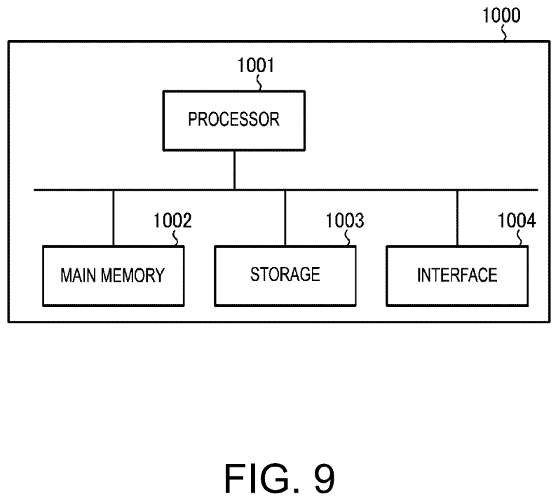

FIG. 9 is a block diagram illustrating a computer system 1000 according to an embodiment. Each of the remote controller 7, the management controller 19, the relay controller 11, and the in-vehicle controller 3 described above includes the computer system 1000. The computer system 1000 includes a processor 1001 such as a central processing unit (CPU), a main memory 1002 including a non-volatile memory such as a read only memory (ROM) and a volatile memory such as a random access memory (RAM), a storage 1003, and an interface 1004 including an input/output circuit. Each function of the remote controller 7, the management controller 19, the relay controller 11, and the in-vehicle controller 3 described above is stored in the storage 1003 as a computer program. The processor 1001 reads out the computer program from the storage 1003, deploys the computer program into the main memory 1002, and executes the above-described process in accordance with the program. The computer program may be distributed to the computer system 1000 via a network.

According to the above-described embodiment, the management controller 19 connects communication between a specific remote controller 7 associated with the remote operation device 6 and a specific relay controller 11 associated with the work machine 2, the remote controller 7 transmits an operation command on the basis of an operation signal from the remote operation device 6, the relay controller 11 receives the operation command transmitted from the remote controller 7, the operation command transmitter 13 transmits the operation command relayed by the relay controller 11 to the work machine 2, and the work machine 2 operates on the basis of the operation command transmitted from the operation command transmitter 13.

### Other Embodiments

In the embodiment, the second communication system 17 communicates by using a radio control method. The second communication system 17 may communicate by using a wireless local area network (LAN) method or a wireless personal area network (PAN) method.

In the above-described embodiment, the work machine 2 is a hydraulic excavator. The work machine 2 only needs to include a work implement and may be a bulldozer or a wheel loader. Further, the work machine 2 need not include a work implement. The work machine 2 may be, for example, a transport vehicle including a dump body.

### REFERENCE SIGNS LIST

1 Remote operation system, 2 Work machine, 2A Work machine, 2B Work machine, 3 In-vehicle controller, 3A In-vehicle controller, 3B In-vehicle controller, 4 Work site, 4A Work site, 4B Work site, 5 Remote operation room, 5A Remote operation room, 5B Remote operation room, 6 Remote operation device, 6A Remote operation device, 6B Remote operation device, 7 Remote controller, 7A Remote controller, 7B Remote controller, 8 Display device, 8A Display device, 8B Display device, 9 Operator, 9A Operator, 9B Operator, 10 Relay room, 10A Relay room, 10B Relay room, 11 Relay controller, 11A Relay controller, 11B Relay controller, 12 Display device, 12A Display device, 12B Display device, 13 Operation command transmitter, 13A Operation command transmitter, 13B Operation command transmitter, 14 Conversion device, 14A Conversion device, 14B Conversion device, 16 First communication system, 16A First communication system, 16B First communication system, 17 Second communication system, 17A Second communication system, 17B Second communication system, 18 Server room, 19 Management controller, 20 Display device, 20A First display area, 20B Second display area, 20C Message, 20D Message, 20E Message, 20F Message, 20G Message, 21 Input device, 22 Manager, 23 Dump truck, 24 Database server, 31 Operation control unit, 32 Image transmission unit, 41 Revolving body, 42 Traveling body, 43 Work implement, 43A Boom, 43B Arm, 43C Bucket, 44 Peripheral camera, 45 Site camera, 46 Operation command receiver, 71 Assignment request unit, 72 Operation command transmission unit, 111 Operation command reception unit, 191 Construction data acquisition unit, 192 Display control unit, 193 Input data acquisition unit, 194 Assigning unit, 1000 Computer system, 1001 Processor, 1002 Main memory, 1003 Storage, 1004 Interface.

1. A remote operation system for a work machine, the remote operation system comprising:
a remote controller associated with a remote operation device and configured to transmit, based on an operation signal from the remote operation device, an operation command;
a relay controller associated with a work machine and configured to receive the operation command;
an operation command transmitter configured to transmit the operation command relayed by the relay controller to the work machine; and
a management controller configured to connect communication between the remote controller that is specific and the relay controller that is specific.

2. The remote operation system for a work machine according to claim 1, wherein
the remote operation device and the remote controller are disposed in a remote operation room installed at a remote location of a work site where the work machine operates, and
the relay controller and the operation command transmitter are disposed in a relay room installed at the work site.

3. The remote operation system for a work machine according to claim 1, wherein the management controller connects, based on construction data indicating a work situation of the work site where the work machine operates, the communication.

4. The remote operation system for a work machine according to claim 3, wherein the management controller specifies, based on the construction data, from among a plurality of the relay controllers, a relay controller to which communication with the remote controller is to be connected.

5. The remote operation system for a work machine according to claim 4, wherein the management controller connects, based on input data from an input device operated based on the construction data, the communication.

6. The remote operation system for a work machine according to claim 1, wherein
the management controller connects, based on an optional setting by a manager, the communication between the relay controller and the remote controller.

7. The remote operation system for a work machine according to claim 5, comprising
a camera configured to capture an image of the work site, wherein
the management controller causes a display device to display the image of the work site captured by the camera, and
the construction data comprises the image of the work site.

8. The remote operation system for a work machine according to claim 7, wherein
the construction data comprises scheduled work start times of a plurality of the work machines, and
the management controller connects, based on the scheduled work start times, the communication.

9. The remote operation system for a work machine according to claim 1, wherein
an operation command transmitted from the remote controller comprises a first operation command of a first communication method, and
an operation command transmitted from the operation command transmitter comprises a second operation command of a second communication method.

10. A remote operation method for a work machine, the remote operation method comprising:
causing a management controller to connect communication between a remote controller that is specific and associated with a remote operation device and a relay controller that is specific and associated with a work machine;
causing the remote controller to transmit, based on an operation signal from the remote operation device, an operation command;
causing the relay controller to receive the operation command transmitted from the remote controller;
causing an operation command transmitter to transmit the operation command relayed by the relay controller to the work machine; and
causing the work machine to operate based on the operation command transmitted from the operation command transmitter.
